(19) United States
(12) Patent Application Publication
(10) Pub. No.: US 2025/0363821 A1
(43) Pub. Date: Nov. 27, 2025

(54) INFORMATION PROCESSING DEVICE, INFORMATION PROCESSING METHOD, AND PROGRAM

(71) Applicant: OMRON Corporation, Kyoto-shi, KYOTO (JP)

(72) Inventor: Daiki SHINKAWA, Kyoto-shi, KYOTO (JP)

(21) Appl. No.: 18/874,841

(22) PCT Filed: Jun. 19, 2023
(86) PCT No.: PCT/JP2023/022618

§ 371 Date: Dec. 13, 2024

(30) Foreign Application Priority Data
Jul. 7, 2022 (JP) 2022-109854

(51) Int. Cl. G06V 40/10; G06V 10/74

(52) U.S. Cl. CPC G06V 40/10; G06V 10/761

(57) ABSTRACT

An information processing device includes a storage unit that stores color information of a human body as reference color information, a detection unit that detects a human body candidate from a captured image captured by a fisheye camera, and a human body determination unit that acquires, from the storage unit, the reference color information corresponding to a detection area where the human body candidate is detected and then determines whether the human body candidate is a human body on the basis of a similarity between the acquired reference color information of the detection area and color information of the human body candidate.

### TECHNICAL FIELD

The present invention relates to an information processing device and an information processing method.

### BACKGROUND ART

In recent years, in a factory automation (FA) market, applications using fisheye top-down cameras have been used for analyzing human movements and improving processes in line production systems, cell production systems, and the like. In order to analyze human movements, accuracy of human body detection needs to be improved. Patent Document 1 discloses a technique for determining whether a hue of a face candidate area extracted from a captured image is skin color to identify a face candidate area that is highly likely to be a human face as a face area.

### CITATION LIST

### Patent Literature

Patent Document 1: JP 2009-123081 A

### SUMMARY OF INVENTION

### Technical Problem

In a top-down image captured by a fisheye camera installed on a ceiling or the like, appearance of a person changes depending on a position in the image, and thus, color information of the person to be detected varies depending on a position at which the person is detected. Therefore, even when using color information from captured images captured by a fisheye camera, it may be difficult to reduce erroneous detections.

An object of one aspect of the present invention is to provide a technique for reducing erroneous detections of a human body in top-down images captured by a fisheye camera.

### Solution to Problem

To achieve the above-mentioned object, the present invention adopts the following configurations.

A first aspect of the present disclosure is an information processing device that includes a storage unit that stores color information of a human body as reference color information, a detection unit that detects a human body candidate from a captured image captured by a fisheye camera, and a human body determination unit that acquires, from the storage unit, the reference color information corresponding to a detection area where the human body candidate is detected, and determines whether the human body candidate is a human body on the basis of a similarity between the acquired reference color information corresponding to the detection area and color information of the human body candidate.

The information processing device compares the color information of the human body candidate with the reference color information corresponding to a position where the human body candidate is detected (detection area), thereby accurately determining whether the detected human body candidate is a human body, and reducing erroneous detections of a human body in top-down images captured by a fisheye camera.

The captured image captured by the fisheye camera is divided into multiple areas, and the storage unit may store color information of a human body detected in each of the multiple areas as the reference color information. By preparing the reference color information for each of the multiple areas, the information processing device can accurately determine whether the detected human body candidate in the area is a human body.

The information processing device may further include a generation unit that generates the reference color information corresponding to the area from the color information of the human body detected in the area and stores the reference color information in the storage unit. By including the generation unit, the information processing device can generate and update the reference color information while executing the human body detection processing. The information processing device can continuously update the reference color information, thereby suppressing deterioration in accuracy of the human body detection due to changes over time in a background, human features, and the like.

The generation unit may generate the reference color information corresponding to the area based on pieces of color information of the human body detected in the area in multiple captured images. The information processing device can create a more average color information map by generating reference color information corresponding to each area from the multiple captured images for training.

When a correlation coefficient between color information of the human body newly detected in the area and the reference color information corresponding to the area is equal to or greater than a first threshold, the generation unit may update the reference color information corresponding to the area based on the color information of the human body newly detected in the area, and when the correlation coefficient between color information of the human body newly detected in the area and the reference color information corresponding to the area is less than a second threshold that is equal to or less than the first threshold, the generation unit may store the color information of the human body newly detected in the area in the storage unit as new reference color information corresponding to the area. The information processing device stores color information having a different feature from a captured image for training in the storage unit as new reference color information. By associating each area with multiple pieces of reference color information, the information processing device can accurately detect a human body even when detecting a person having a different color feature.

The reference color information may be generated based on pixel values in a frame surrounding the human body detected in the area, and the color information of the human body candidate may be generated based on pixel values in a frame surrounding the human body candidate. The information processing device can suppress erroneous detections based on a difference in pixel values between the human body and the human body candidate.

The reference color information may be generated based on pixel values in the frame surrounding the human body detected in the area excluding a background of the captured image, and the color information of the human body candidate may be generated based on pixel values in the frame surrounding the human body candidate excluding a background of the captured image. By generating the color information excluding the background, the information processing device can generate reference color information and color information only from the actual human body and the human body candidate, thereby accurately detecting the human body.

The reference color information may be a histogram of the pixel values in the frame surrounding the human body detected in the area, and the color information of the human body candidate may be a histogram of the pixel values in the frame surrounding the human body candidate. The information processing device can suppress erroneous detections based on a difference in distribution of pixel values between the human body and the human body candidate.

The human body determination unit may determine that the human body candidate is a human body when a correlation coefficient between the histogram of the color information of the human body candidate and the histogram of the reference color information corresponding to the detection area is equal to or greater than a predetermined threshold. The information processing device can determine whether the human body candidate is a human body based on the correlation coefficient (similarity) between the histograms. By changing the predetermined threshold, the information processing device can adjust detection accuracy for differences in color features.

The histogram of the pixel values may include histograms for RGB. The human body determination unit may determine whether the human body candidate is a human body based on a mean value, a maximum value, or a minimum value of correlation coefficients between the histograms for RGB of the color information of the human body candidate and the histograms for RGB of the reference color information corresponding to the detection area. The information processing device can suppress erroneous detections when color features differ between the human body and the human body candidate.

The reference color information may be a most frequent value or a mean value of RGB of pixels in the frame surrounding the human body detected in the area, and the color information of the human body candidate may be a most frequent value or a mean value of RGB of pixels in the frame surrounding the human body candidate. The information processing device can accurately detect a human body by comparing the color information of a human body candidate with the reference color information by a simple calculation.

The reference color information may be information obtained by averaging pieces of color information of the human body detected in the area in multiple captured images. The reference color information may be a trained model trained using color information of the human body detected in the area in the multiple captured images as training data and outputs whether the input color information of the human body candidate is color information of the human body to be detected in the detection area. The information processing device can create a more average color information map by generating reference color information corresponding to each area from the multiple captured images for training.

The area may be associated with multiple pieces of reference color information. The information processing device can accurately detect a human body even when detecting a person having a different color feature.

The information processing device may further include an output unit that presents the human body candidate determined to be a human body by the human body determination unit to a user as a detection result of a human body. The information processing device can present a detection result of a human body to the user in consideration of color information.

The storage unit may store the reference color information corresponding to a distance from a center position of a captured image captured by a fisheye camera. By preparing the reference color information corresponding to the distance from the center position of the captured image, the information processing device can accurately determine whether the human body candidate detected at this distance is a human body.

In a second aspect of the present invention, an information processing method executed by a computer includes the steps of: storing, in the storage unit, color information of a human body detected in a plurality of areas obtained by dividing the captured image captured by the fisheye camera, for each of the plurality of areas as the reference color information; detecting a human body candidate from the captured image; and acquiring, from the storage unit, reference color information corresponding to a detection area where the human body candidate is detected, and then determining whether the human body candidate is a human body on the basis of a similarity between the acquired reference color information corresponding to the detection area and color information of the human body candidate.

The present invention can be regarded as a program for implementing such a method by a computer, and a recording medium in which the program is non-transitory recorded. Note that the present invention can be implemented by combining each piece of the above-described processing as much as possible.

### Advantageous Effects of Invention

According to the present invention, erroneous detections of a human body in top-down images captured by a fisheye camera can be reduced.

### BRIEF DESCRIPTION OF DRAWINGS

FIG. 1 is a diagram illustrating an application example of an information processing device according to an embodiment.

FIG. 2 is a diagram illustrating a hardware configuration of the information processing device.

FIG. 3 is a diagram illustrating a functional configuration of the information processing device.

FIG. 4 is a flowchart illustrating human body detection processing.

FIG. 5 is a diagram illustrating color information according to a first modified example.

FIG. 6 is a diagram illustrating color information according to a second modified example.

FIG. 7 is a diagram illustrating a color information map according to a third modified example.

FIG. 8 is a diagram illustrating a color information map according to a fourth modified example.

### DESCRIPTION OF EMBODIMENTS

Embodiments according to one aspect of the present invention will be described below on the basis of the drawings.

### Application Example

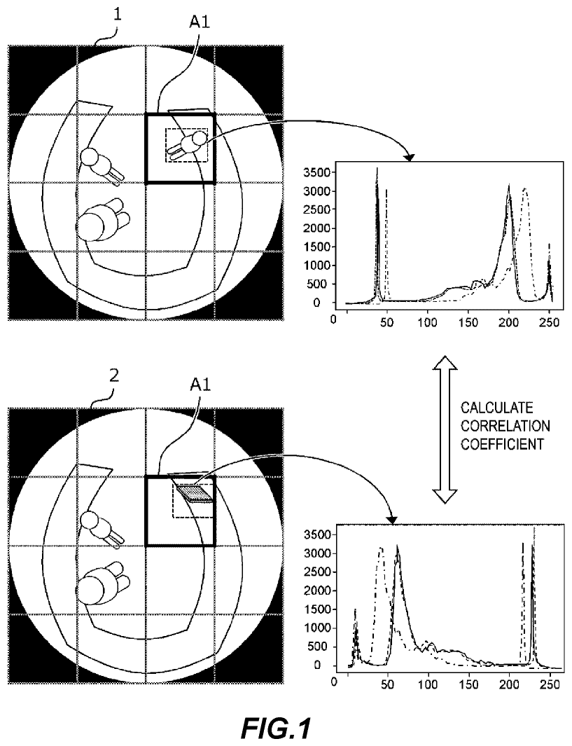

FIG. 1 is a diagram illustrating an application example of an information processing device according to an embodiment. The information processing device detects a subject recognized as a human body (hereinafter, referred to as a human body candidate) from a camera image captured by a camera (captured image), and determines whether the human body candidate is a human body using color information.

The information processing device divides the captured image into multiple areas and acquires (generates) color information of a human body detected in each area. In the example in FIG. 1, a captured image 1 for training is divided into 4×4 rectangular areas. The information processing device generates histograms for RGB as color information of a human body for pixels in a frame surrounding the human body detected in an area A1. The generated color information is stored in a storage unit as color information that serves as a reference for determining whether a human body candidate is a human body (hereinafter, referred to as reference color information). The reference color information is color information of a human body detected in each area, and is generated for each of the multiple areas obtained by dividing the captured image.

The information processing device detects a human body candidate in a captured image as a detection target and generates color information of the human body candidate. A lower part of FIG. 1 illustrates an example in which the information processing device detects a personal computer (PC) as a human body candidate in an area A1 of a captured image 2. The information processing device generates histograms for RGB as color information of the human body candidate for pixels in a frame surrounding the detected PC.

The information processing device compares the color information of the PC detected in the area A1 of the captured image 2 with the reference color information in the area A1, and determines whether the PC detected as the human body candidate is a human body based on a similarity between the color information of the PC and the reference color information. The information processing device, for example, calculates a correlation coefficient between a histogram of the color information of the human body candidate (PC) and a histogram of the reference color information as a similarity, and can determine that the human body candidate is a human body when the correlation coefficient is equal to or greater than a predetermined threshold.

The correlation coefficient can be calculated by various known methods, for example, as a value of 0 or more and 1 or less. In the example in FIG. 1, the information processing device calculates correlation coefficients between the histograms for RGB, and can use, for example, a mean value of three correlation coefficients as a correlation coefficient for determining whether the human body candidate is a human body. The predetermined threshold can be, for example, a value of 0.6 or more and 0.9 or less. By increasing the predetermined threshold, the information processing device can more accurately determine whether the human body candidate is a human body.

The camera used for capturing images for human body detection is an ultra-wide-angle camera equipped with a fisheye lens capable of acquiring image information over a wide range. A camera equipped with a fisheye lens is referred to as a fisheye camera, an omnidirectional camera, a 360-degree camera, or the like. Here, the term “fisheye camera” is used.

Images captured by a fisheye camera have distortions in appearance of the captured subject depending on the position thereof in the captured image. For example, when the fisheye camera is placed on the ceiling looking down at a floor, a person in the captured image has his or her feet facing the center and the top of his or her head facing outward. The human body appears as a front image, a back image, or a side image at a periphery of the captured image, and appears as a top image at the center of the captured image.

Therefore, even for the same person or a person wearing the same uniform, the color information generated varies depending on the detected area. The information processing device can accurately determine whether a human body candidate is a human body by comparing the color information of the human body candidate with the reference color information corresponding to the area where the human body candidate is detected (detection area). Therefore, the information processing device can reduce erroneous detections of a human body in top-down images captured by a fisheye camera.

Note that when detecting a human body candidate from a captured image captured by a camera installed at a specific location, the information processing device detects the human body candidate mainly from a background difference obtained by removing a background image from the captured image. In this case, an object included in the background difference is more likely to be detected as a human body candidate even when the object is not a human body. In particular, when detecting a human body using a model trained to detect a human body in a specific environment, an object that is not included in the background and has a different color may be detected as a human body. The information processing device can reduce erroneous detections of an object from a background difference by determining whether the object is a human body using color information.

### EMBODIMENTS

### (Hardware Configuration)

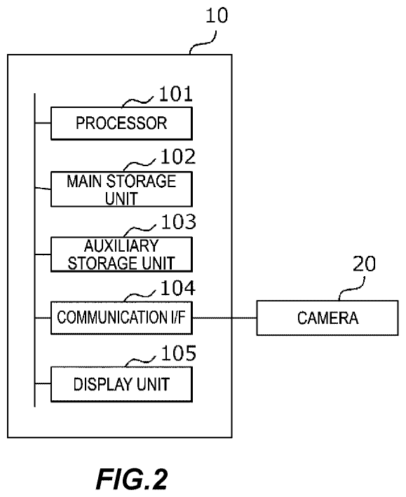

With reference to FIG. 2, an example of a hardware configuration of an information processing device 10 will be described. FIG. 2 is a diagram illustrating the hardware configuration of the information processing device 10. The information processing device 10 includes a processor 101, a main storage unit 102, an auxiliary storage unit 103, a communication interface (I/F) 104, and a display unit 105.

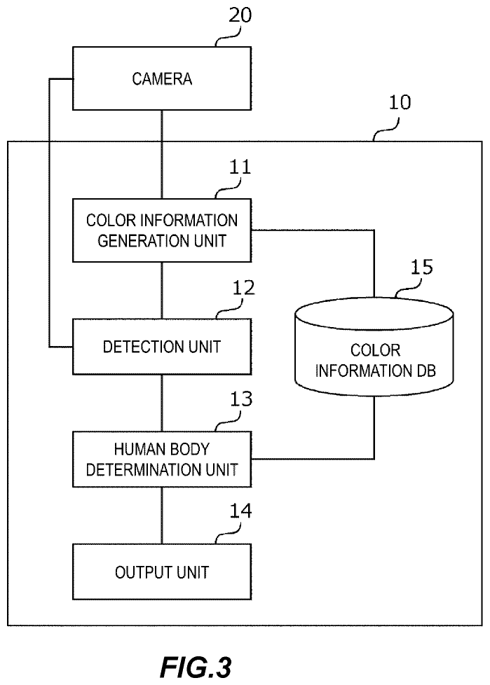

The processor 101 reads out a program stored in the auxiliary storage unit 103 to the main storage unit 102 and executes the program, thereby implementing functions as functional configurations described in FIG. 3. The main storage unit 102 is a semiconductor memory such as a random access memory (RAM) or a read only memory (ROM). The auxiliary storage unit 103 is a non-volatile memory such as a hard disk drive or a solid state drive.

The communication interface 104 is an interface for wired (such as a USB cable or a LAN cable) or wireless (such as WiFi) communication. The display unit 105 is a display or the like for displaying results of human body detection.

The information processing device 10 may be a general-purpose computer such as a personal computer, a server computer, a tablet terminal, or a smartphone, or may be an embedded computer such as an on-board computer. In the information processing device 10, part of processing of functional units may be implemented by a cloud server. Also, part of processing of functional units of the information processing device 10 may be implemented by dedicated hardware devices such as FPGAs or ASICs.

The information processing device 10 is wired or wirelessly connected to a camera 20, and receives image data (captured image) captured by the camera 20. The camera 20 is an imaging device including an optical system including a lens and an image sensor (such as a CCD or a CMOS).

Note that part of the processing of the information processing device 10 may be executed by the camera 20. A result of the human body detection by the information processing device 10 may be transmitted to an external device and presented to a user. Furthermore, the information processing device 10 may be integrated with the camera 20.

### (Functional Configuration)

With reference to FIG. 3, an example of a functional configuration of the information processing device 10 will be described. FIG. 3 is a diagram illustrating the functional configuration of the information processing device 10. The information processing device 10 includes a color information generation unit 11, a detection unit 12, a human body determination unit 13, an output unit 14, and a color information database 15 (color information DB 15).

The color information generation unit 11 acquires a captured image captured by the camera 20, and generates, for each of multiple areas obtained by dividing the captured image, reference color information corresponding to this area from color information of a human body detected in this area. Data of the reference color information associated with each area obtained by dividing the captured image is also referred to as a color information map.

The color information is generated based on pixel values in a frame surrounding a detected human body. For example, the color information generation unit 11 generates information in which pixel values (luminance values) of pixels in a frame surrounding a human body as a histogram as reference color information corresponding to an area where the human body is detected. The color information generation unit 11 may generate histograms for RGB as the reference color information. The color information generation unit 11 stores the generated reference color information in the color information database 15 in association with the area where the human body is detected.

Similar to the reference color information, the color information generation unit 11 can generate color information of a human body candidate detected from the captured image. The color information of the human body candidate is used by the human body determination unit 13 to determine whether the human body candidate is a human body. The color information generation unit 11 is an example of a “generation unit”.

The detection unit 12 acquires a captured image captured by the camera 20 and detects a human body candidate from the captured image. The detection unit 12 can detect a human body candidate using a common object recognition algorithm. For example, the detection unit 12 can detect a human body candidate using a discriminator that combines image features such as HoG or Haar-like with boosting. Alternatively, the detection unit 12 may detect a human body candidate using a human body recognition algorithm based on deep learning (e.g., R-CNN, Faster R-CNN, YOLO, SSD, etc.).

The human body determination unit 13 determines whether the human body candidate detected by the detection unit 12 is a human body. The human body determination unit 13 determines whether the human body candidate is a human body based on a similarity between reference color information corresponding to a detection area where the human body candidate is detected among multiple areas of the captured image and color information of the human body candidate. The detection area may be, for example, an area where a center position of a rectangular frame surrounding the human body candidate is detected.

The output unit 14 outputs the human body candidate determined to be a human body by the human body determination unit 13 as a detection result of a human body. The output unit 14 can present the detection result of a human body to the user by, for example, superimposing a rectangle surrounding the detected human body on the captured image.

The color information database 15 stores a color information map created in advance by the color information generation unit 11. The color information map includes areas into which the captured image is divided and data on reference color information associated with the areas. The reference color information in the color information map may be updated while the human body detection processing is being executed. The color information database 15 is an example of a “storage unit”.

### (Human Body Detection Processing)

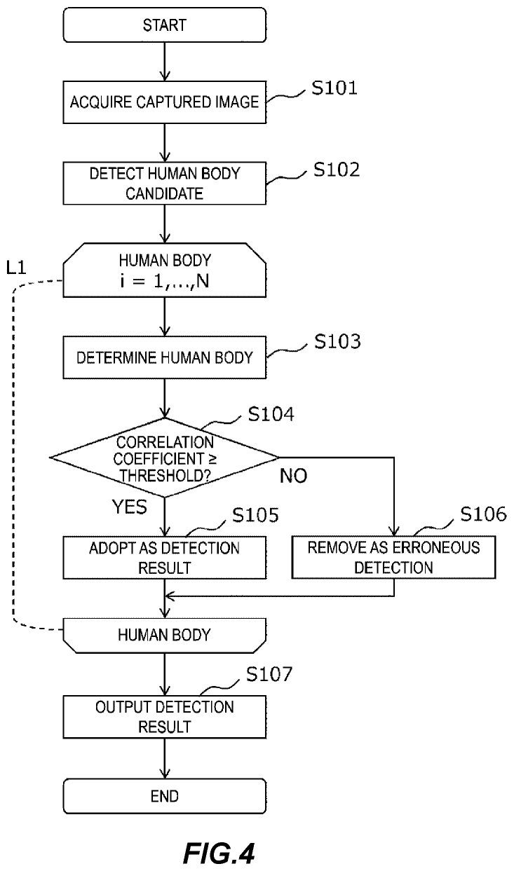

With reference to FIG. 4, an overall flow of the human body detection processing will be described. FIG. 4 is a flowchart illustrating human body detection processing. The human body detection processing is started, for example, when the camera 20 is powered on and the information processing device 10 receives a captured image from the camera 20. Note that the human body detection processing illustrated in FIG. 4 is processing executed for each frame (captured image) of image data received from the camera 20. It is assumed that the color information map is created in advance by the color information generation unit 11 and stored in the color information database 15.

In step S101, the detection unit 12 acquires a captured image. The detection unit 12 can acquire the captured image from the camera 20 via the communication interface 104. Note that when the information processing device 10 is integrated with a camera (imaging unit), the color information generation unit 11 acquires the captured image captured by the imaging unit.

In step S102, the detection unit 12 detects a human body candidate from the captured image acquired in step S101. The detection unit 12 can detect a human body candidate using a known technique such as deep learning. When multiple human body candidates are detected in step S102, human body determination processing L1 from step S103 to step S106 is executed for each human body candidate.

In step S103, the human body determination unit 13 determines whether the human body candidate detected in step S102 is a human body. First, the human body determination unit 13 acquires, from the color information database 15, reference color information corresponding to a detection area where the human body candidate is detected among multiple areas obtained by dividing the captured image. Subsequently, the human body determination unit 13 determines whether the human body candidate is a human body based on a similarity between the acquired reference color information corresponding to the detection area and the color information of the detected human body candidate. The color information of the human body candidate is acquired by the color information generation unit 11.

The color information is a histogram for RGB, as illustrated in FIG. 1. In this case, the human body determination unit 13 calculates correlation coefficients between the histograms for RGB of the color information of the human body candidate and the histograms for RGB of the reference color information.

In step S104, the human body determination unit 13 determines whether the correlation coefficient calculated in step S103 is equal to or greater than a predetermined threshold. For example, when a mean value, a maximum value, or a minimum value of each of the correlation coefficients of the histograms for RGB is equal to or greater than a predetermined threshold, the human body determination unit 13 determines that the human body candidate is a human body. Note that the human body determination unit 13 may determine that the human body candidate is a human body when the correlation coefficients of the histograms for RGB are all equal to or greater than a predetermined threshold.

When the correlation coefficient is equal to or greater than the predetermined threshold, and thus the human body candidate is determined to be a human body (step S104: YES), the processing proceeds to step S105. When the correlation coefficient is less than the predetermined threshold, and thus the human body candidate is determined to be not a human body (step S104: NO), the processing proceeds to step S106.

In step S105, the human body determination unit 13 adopts as a result of detection that the human body candidate to be determined is a human body, and stores the detection result in the auxiliary storage unit 103 or the like. In step S106, the human body determination unit 13 removes the human body candidate to be determined as an erroneous detection.

When the human body determination processing L1 is executed for all human body candidates detected in step S102, the processing proceeds to step S107. In step S107, the output unit 14 outputs information on the human body adopted as the detection result in step S105. The output unit 14 may display the detection result on the display unit 105. The output unit 14 can present the detection result of a human body to the user by, for example, superimposing a rectangle surrounding the detected human body on the captured image. The output unit 14 may output the detection result to an external device to display the detection result on a display or the like of the external device.

When the human body detection processing for the current frame (captured image) is completed, the human body detection processing for the next frame is started. The information processing device 10 repeatedly executes the human body detection processing in FIG. 4 until the imaging processing by the camera 20 is stopped.

In the above embodiment, the information processing device 10 detects a human body candidate from a captured image, and determines whether the human body candidate is a human body based on the similarity between the reference color information corresponding to the detection area where the human body candidate is detected and the color information of the human body candidate. Images captured by the fisheye camera look different depending on the positions at which the images are captured. However, the information processing device 10 can accurately determine whether the detected human body candidate is a human body by comparing the color information of the human body candidate with the reference color information corresponding to the position (detection area) at which the human body candidate is detected. Therefore, the information processing device 10 can reduce erroneous detections of a human body in top-down images captured by a fisheye camera.

### First Modified Example

The above embodiment illustrates an example in which the color information is a histogram of pixel values. A first modified example is an example in which the color information is a most frequent value of RGB of pixels in a frame surrounding a human body or a human body candidate. Note that the color information is not limited to the most frequent value, and may be a mean value of RGB of pixels in a frame surrounding a human body or a human body candidate.

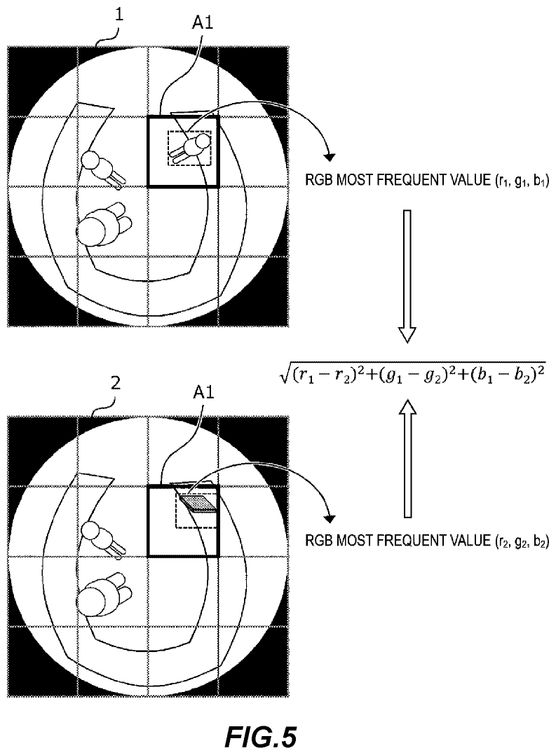

FIG. 5 is a diagram illustrating color information according to the first modified example. A captured image 1 is a captured image for training purposes for generating reference color information, and a captured image 2 is a captured image for detection of a human body.

The color information generation unit 11 acquires a most frequent value of RGB (r₁, g₁, b₁) for pixels in a frame surrounding a human body detected in an area A1 of the captured image 1, and stores the most frequent value in the color information database 15 as reference color information corresponding to the area A1. The color information generation unit 11 also acquires a most frequent value of RGB (r₂, g₂, b₂) for pixels in a frame surrounding a PC (human body candidate) detected in an area A1 of the captured image 2, as color information of the human body candidate. The most frequent value is a pixel value that appears most frequently among pixels in a frame surrounding a human body or a human body candidate. r₁, g₁, b₁, r₂, g₂, and b₂ are represented by values from 0 to 255.

The human body determination unit 13 calculates a distance d between the most frequent value of RGB (r₁, g₁, b₁) of the reference color information and the most frequent value of RGB (r₂, g₂, b₂) of the color information of the human body candidate by the following (Equation 1).

$$\begin{matrix}[ Math . 1 ] & \\ d = \sqrt{{( {r}_{1} - {r}_{2} )}^{2} + {( {g}_{1} - {g}_{2} )}^{2} + {( {b}_{1} - {b}_{2} )}^{2}} & ( Equation 1 )\end{matrix}$$

The human body determination unit 13 can determine that the human body candidate is a human body when the distance d is equal to or less than a predetermined threshold, and can determine that the human body candidate is not a human body when the distance d is greater than the predetermined threshold. Note that a correlation coefficient may be calculated, for example, by defining a conversion equation such that the correlation coefficient increases as the distance d decreases. In this case, as in the case of the histogram, the human body determination unit 13 can determine whether a human body candidate is a human body by comparing the correlation coefficient with a predetermined threshold.

According to the first modified example, the information processing device 10 can accurately detect a human body by comparing the color information of a human body candidate with the reference color information by a simple calculation.

### Second Modified Example

A second modified example is an example in which color information is generated based on pixel values in a frame surrounding a human body or a human body candidate, excluding pixels in a background. By excluding pixels in the background, the color information generation unit 11 can more accurately generate color information of a human body or a human body candidate.

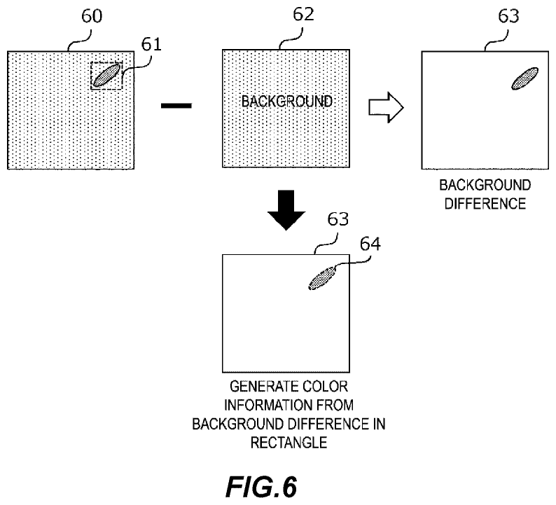

FIG. 6 is a diagram illustrating color information according to the second modified example. FIG. 6 describes an example in which color information of a detected human body candidate is generated from a captured image 60 for detection. The color information generation unit 11 can also generate reference color information of a human body from a captured image for training in a similar manner.

The detection unit 12 detects a human body candidate from the captured image 60. Since a background image is included in a rectangular frame 61 surrounding the human body candidate, when color information is generated from pixel values in the frame 61, the generated color information includes color information of the background other than the human body candidate. Therefore, the color information generation unit 11 acquires a background difference 63, which is a difference between the captured image 60 and a background image 62, and generates color information from a human body candidate 64 in the background difference 63.

According to the second modified example, the information processing device 10 can generate reference color information and color information only from the actual human body and the human body candidate by generating the color information excluding the background, thereby accurately detecting the human body.

### Third Modified Example

The above embodiment illustrates an example in which reference color information corresponding to each area is generated from one captured image for training. A third modified example is an example in which reference color information corresponding to each area is generated from multiple captured images for training, and a color information map is created.

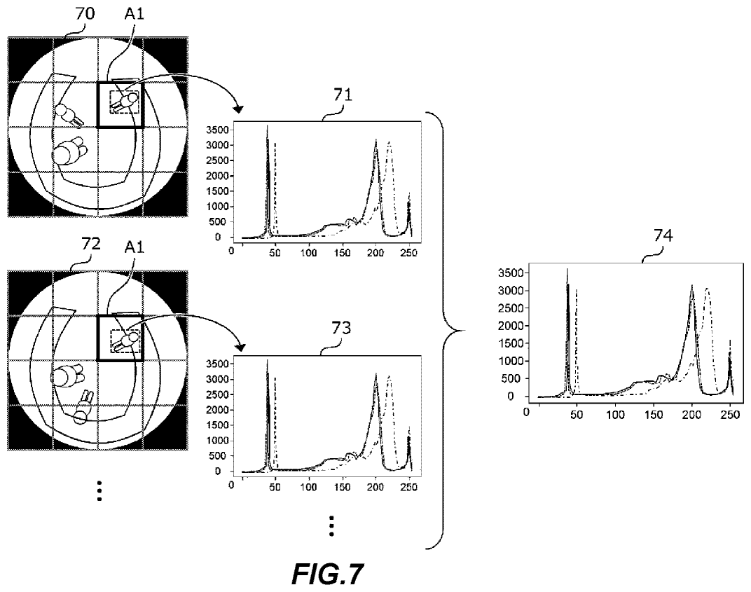

FIG. 7 is a diagram illustrating a color information map according to the third modified example. The color information generation unit 11 generates, for example, by averaging color information 71 of a human body detected in an area A1 of a captured image 70 and color information 73 of a human body detected in an area A1 of a captured image 72, reference color information 74 corresponding to an area A1.

The color information generation unit 11 may generate the reference color information from three or more captured images, not limited to two captured images 70 and 72. Alternatively, the color information generation unit 11 may generate, as the reference color information, a trained model trained using color information of the human body detected in the area A1 in the multiple captured images for training as training data. This trained model outputs whether input color information of a human body candidate is color information of a human body to be detected in the detection area.

According to the third modified example, the information processing device 10 can create a more average color information map by generating reference color information corresponding to each area from the multiple captured images for training.

### Fourth Modified Example

Similar to the third modified example, a fourth modified example is an example in which reference color information corresponding to each area is generated from multiple captured images for training, and a color information map is created. The third modified example is an example in which one piece of reference color information is generated from the multiple captured images for training, whereas the fourth modified example is an example in which multiple pieces of reference color information are generated from the multiple captured images for training. In the fourth modified example, when a correlation coefficient between color information generated from any of the captured images for training and the current reference color information is less than a predetermined threshold, this color information is held as new reference color information.

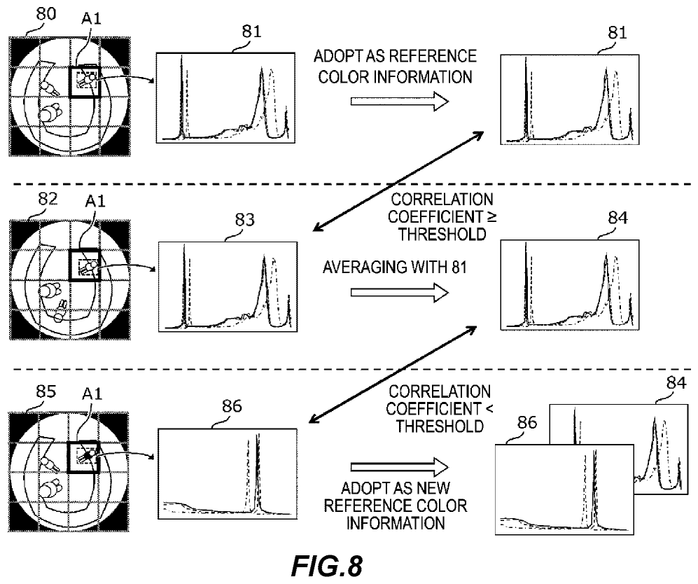

FIG. 8 is a diagram illustrating a color information map according to the fourth modified example. First, the color information generation unit 11 adopts color information 81 of a human body detected in a captured image 80 as reference color information 81 in an area A1.

Subsequently, the color information generation unit 11 generates color information 83 of the human body newly detected in a captured image 82, and calculates a correlation coefficient between the color information 83 and the reference color information 81. When the correlation coefficient is equal to or greater than a predetermined threshold (first threshold), the color information generation unit 11 updates the reference color information 81 based on the color information 83. The color information generation unit 11 updates the reference color information 81 to reference color information 84 by, for example, averaging the reference color information 81 and the color information 83. The first threshold can be, for example, a value of 0.6 or more and 0.9 or less.

Further, the color information generation unit 11 generates color information 86 of the human body newly detected in a captured image 85, and calculates a correlation coefficient between the color information 86 and the reference color information 84. When the correlation coefficient is less than a predetermined threshold (second threshold), the color information generation unit 11 adopts the color information 86 as new reference color information 86 in the area A1 and stores the reference color information 86 in the color information database 15. The second threshold is equal to or less than the first threshold, and may be, for example, a value of 0.3 or more and 0.6 or less.

Furthermore, for another captured image for training, the color information generation unit 11 similarly calculates a correlation coefficient between the color information of the human body newly detected and the reference color information 84 and the reference color information 86, respectively. When the correlation coefficient is equal to or greater than the first threshold, the color information generation unit 11 updates the reference color information based on the color information of the human body newly detected. When the correlation coefficient is less than the second threshold for any reference color information, the color information generation unit 11 adopts the color information of the human body newly detected as new reference color information in the area A1, and stores this reference color information in the color information database 15.

According to the fourth modified example, when color information having a different feature is generated from a captured image for training, the information processing device 10 stores the generated color information in the color information database 15 as new reference color information. By associating each area with multiple pieces of reference color information, the information processing device 10 can accurately detect a human body even when detecting a person wearing a uniform of a different color.

In addition, by adopting multiple pieces of reference color information in each area, information such as a frequency with which a person having a different feature is detected can be obtained. This information can be used as information useful for process improvement in factory automation.

### Fifth Modified Example

In the above embodiment, an example is described in which the color information map including the reference color information for each area is prepared in advance. However, the color information map may be generated and updated during the human body detection processing. When the human body candidate is determined to be a human body in step S105 of the human body detection processing illustrated in FIG. 4, the human body determination unit 13 updates the reference color information by averaging the color information of the human body candidate determined to be a human body with the current reference color information.

According to the fifth modified example, the information processing device 10 can continuously update the reference color information, thereby suppressing deterioration in accuracy of the human body detection due to changes over time in the background, human features, and the like.

### <Other>

The above embodiment and modified examples are merely illustrative of configuration examples of the present invention. The present invention is not limited to the specific aspects described above, and various combinations and modifications are possible within the scope of the technical idea of the present invention.

Note that in the embodiment and the modified examples described above, the captured image is divided into 4×4 rectangular areas and the human body detection processing is executed. However, the method of dividing the captured image is not limited to 4×4 rectangular areas. The number of divided areas may be more or less than 4×4. The shape of the divided areas is not limited to rectangular, and may be concentric circular. The information processing device 10 is not limited to preparing reference color information for each of the divided areas, and may prepare reference color information according to a distance from the center position of the captured image.

### SUPPLEMENTARY NOTE

(1) An information processing device (10) including a storage unit (15) configured to store color information of a human body as reference color information, a detection unit (12) configured to detect a human body candidate from a captured image captured by a fisheye camera, and a human body determination unit (13) configured to acquire, from the storage unit, the reference color information corresponding to a detection area where the human body candidate is detected, and determine whether the human body candidate is a human body on the basis of a similarity between the acquired reference color information corresponding to the detection area and color information of the human body candidate.

(2) An information processing method executed by a computer, the method including the steps of: storing color information of a human body in a storage unit as reference color information; detecting a human body candidate from a captured image captured by a fisheye camera (step S102); and acquiring, from the storage unit, the reference color information corresponding to a detection area where the human body candidate is detected, and then determining whether the human body candidate is a human body on the basis of a similarity between the acquired reference color information corresponding to the detection area and color information of the human body candidate (steps S103 to S106).

### DESCRIPTION OF SYMBOLS

10: information processing device, 11: color information generation unit, 12: detection unit, 13: human body determination unit, 14: output unit, 15: color information database, 20: camera
101: processor, 102: main storage unit, 103: auxiliary storage unit, 104: communication interface, 105: display unit

1. An information processing device, comprising:
a storage unit configured to store color information of a human body as reference color information;
a detection unit configured to detect a human body candidate from a captured image captured by a fisheye camera; and
a human body determination unit configured to acquire, from the storage unit, the reference color information corresponding to a detection area where the human body candidate is detected, and determine whether the human body candidate is a human body on the basis of a similarity between the acquired reference color information corresponding to the detection area and color information of the human body candidate.

2. The information processing device according to claim 1, wherein
the storage unit is configured to store color information of a human body detected in a plurality of areas obtained by dividing the captured image captured by the fisheye camera, for each of the plurality of areas as the reference color information.

3. The information processing device according to claim 2, further comprising
a generation unit configured to generate, from the color information of a human body detected in the plurality of areas, the reference color information corresponding to each of the plurality of areas and store the reference color information in the storage unit.

4. The information processing device according to claim 3, wherein
the generation unit is configured to generate, on the basis of color information of a human body detected in the plurality of areas of a plurality of the captured images, the reference color information corresponding to a corresponding area of the plurality of areas.

5. The information processing device according to claim 3, wherein
the generation unit is configured to,
in a case where a correlation coefficient between color information of a human body newly detected in an area of the plurality of areas and the reference color information corresponding to the area is equal to or greater than a first threshold, update the reference color information corresponding to the area on the basis of the color information of the human body newly detected in the area, and
in a case where the correlation coefficient between the color information of the human body newly detected in the area and the reference color information corresponding to the area is less than a second threshold being equal to or less than the first threshold, store the color information of the human body newly detected in the area in the storage unit as new reference color information corresponding to the area.

6. The information processing device according to claim 2, wherein
the reference color information is generated on the basis of pixel values in a frame surrounding the human body detected in the area, and
the color information of the human body candidate is generated on the basis of pixel values in a frame surrounding the human body candidate.

7. The information processing device according to claim 6, wherein
the reference color information is generated on the basis of pixel values in part excluding a background of the captured image in the frame surrounding the human body detected in the area, and
the color information of the human body candidate is generated on the basis of pixel values in part of excluding a background part of the captured image in the frame surrounding the human body candidate.

8. The information processing device according to claim 6, wherein
the reference color information is a histogram of the pixel values in the frame surrounding the human body detected in the area, and
the color information of the human body candidate is a histogram of the pixel values in the frame surrounding the human body candidate.

9. The information processing device according to claim 8, wherein
the human body determination unit is configured to determine that the human body candidate is a human body in a case where a correlation coefficient between the histogram of the color information of the human body candidate and the histogram of the reference color information corresponding to the detection area is equal to or greater than a predetermined threshold.

10. The information processing device according to claim 8, wherein
the histogram of the pixel values includes histograms for RGB.

11. The information processing device according to claim 10, wherein
the human body determination unit is configured to determine whether the human body candidate is a human body on the basis of a mean value, a maximum value, or a minimum value of correlation coefficients between the histograms for RGB of the color information of the human body candidate and the histograms for RGB of the reference color information corresponding to the detection area.

12. The information processing device according to claim 6, wherein
the reference color information is a most frequent value or a mean value of RGB of pixels in the frame surrounding the human body detected in the area, and
the color information of the human body candidate is a most frequent value or a mean value of RGB of pixels in the frame surrounding the human body candidate.

13. The information processing device according to claim 2, wherein
the reference color information is information obtained by averaging pieces of color information of the human body detected in the plurality of areas in the plurality of captured images.

14. The information processing device according to claim 2, wherein
the reference color information is a trained model, the trained model being trained using, as training data, color information of the human body detected in the plurality of areas in the plurality of captured images, and being configured to output whether color information of the human body candidate input is color information of the human body detected in the detection area.

15. The information processing device according to claim 2, wherein
each of the plurality of areas is associated with a plurality of pieces of the reference color information.

16. The information processing device according to claim 1, further comprising
an output unit configured to present the human body candidate determined to be a human body by the human body determination unit to a user as a result of the detection of a human body.

17. The information processing device according to claim 1, wherein
the storage unit is configured to store the reference color information according to a distance from a center position of the captured image captured by the fisheye camera.

18. An information processing method executed by a computer, the method comprising the steps of:
storing color information of a human body in a storage unit as reference color information;
detecting a human body candidate from a captured image captured by a fisheye camera; and
acquiring, from the storage unit, the reference color information corresponding to a detection area where the human body candidate is detected, and then determining whether the human body candidate is a human body on the basis of a similarity between the acquired reference color information corresponding to the detection area and color information of the human body candidate.

19. A non-transitory computer readable medium storing a program for causing a computer to execute the steps of:
storing color information of a human body in a storage unit as reference color information;
detecting a human body candidate from a captured image captured by a fisheye camera; and
acquiring, from the storage unit, the reference color information corresponding to a detection area where the human body candidate is detected, and then determining whether the human body candidate is a human body on the basis of a similarity between the acquired reference color information corresponding to the detection area and color information of the human body candidate.
